(19) United States
(12) Patent Application Publication
(10) Pub. No.: US 2016/0281769 A1
(43) Pub. Date: Sep. 29, 2016

(54) CABLE ANCHOR ASSEMBLY

(71) Applicant: THE CABLE CONNECTION, Carson City, NV (US)

(72) Inventor: MICHAEL S. KECHELY, Carson City, NV (US)

(73) Assignee: THE CABLE CONNECTION, Carson City, NV (US)

(21) Appl. No.: 14/671,909

(22) Filed: Mar. 27, 2015

(51) Int. Cl. F16C 11/04; F16B 37/00

(52) U.S. Cl. CPC F16C 11/04; F16B 37/00; F16B 2037/007

(57) ABSTRACT

An anchor assembly includes an anchor member, a connector, and a base plate. The anchor member is configured to releasably connect to the connector. The base plate includes inner and outer primary surfaces, an aperture, and an anchor seat. The inner primary surface is configured to contact a surface of a support structure. The aperture extends through the base plate and is receptive of a shank of the connector. The anchor seat is positioned on the inner primary surface and is configured to support the anchor member.

### TECHNICAL FIELD

The present disclosure relates generally to connection systems, and more particularly relates to anchoring devices for use with a connection system.

### BACKGROUND

A number of cable connecting devices are available for securing a free end of a cable to a support structure such as a wall, post, rail, or the like. In one example, a connecting device is formed as a lag screw and is configured to be threaded into the support structure and act as an anchor for attachment of the cable to the support structure. In another example, the connecting device wraps around the support structure (e.g., post or rail) to provide connection of the cable to the support structure. In a further example, the connecting device extends completely through the support structure and is anchored on an opposite or back side of the support structure.

These known solutions for securing a cable to a support structure have disadvantages depending on, for example, the shape, size and materials of the support structure and the load requirements for the cable. Some support structure are so large in size that it is impractical to wrap a connecting device or cable around the support structure. Other support structures have a thickness or material composition that does not permit boring completely through the support structure or extending the connecting device through the support structure.

Opportunities exist for improvements in connecting devices used to secure a cable to a support structure.

### SUMMARY

One aspect of the present disclosure relates to an anchor assembly that includes an anchor member and a base plate. The anchor member is configured to releasably connect to a cable connector. The base plate includes inner and outer primary surfaces, an aperture, and an anchor seat. The inner primary surface is configured to contact a surface of a support structure. The aperture extends through the base plate and is configured to receive a shank of the connector. The anchor seat is positioned on the inner primary surface and is configured to support the anchor member.

The anchor member may include a polymeric material. The anchor member may have a bore that receives a portion of the shank. The anchor member may be pivotally mounted to the anchor seat. The anchor member may be mounted to the anchor seat with an interference fit connection. The base plate may include a boss extending from the inner primary surface and configured to extend into a boss recess formed in an adjacent positioned anchor assembly or in a boss aperture of the support structure. The aperture may have a length and a width, wherein the length is greater than the width to permit pivotal movement of the connector relative to the base plate.

Another aspect of the present disclosure relates to an anchor assembly that includes a base plate, a connector, and an anchor. The base plate has a connector aperture. The connector includes a shank that is configured to extend through the connector aperture. The anchor has a bore that is configured to receive the shank of the connector. A position of the connector is adjustable relative to the anchor and base plate

The base plate may include at least one boss aperture configured to receive at least one boss of an adjacent positioned anchor assembly to connect the base plate to the adjacent positioned anchor assembly. The anchor may be pivotally mounted to the base plate. The anchor may be configured to permit pivotal movement of the connector relative to the base plate. The anchor may be integrally formed as a single piece with the base plate. The anchor may hold the connector in a fixed orientation relative to the base plate. The connector aperture may have an elongate shape. The base plate may include a boss configured to extend into a boss recess formed in an adjacent positioned anchor assembly. The boss may provide a snap-fit connection between the base plate and the adjacent positioned anchor assembly.

A further aspect of the present disclosure relates to a method of connecting to a support structure. The method includes providing an anchor assembly comprising a base plate, a connector, and an anchor member, wherein the base plate has a connector aperture and an anchor seat. The method also includes extending a shank of the connector through the connector aperture and into engagement with the anchor member, positioning the anchor member in the anchor seat, and mounting the base plate to a surface of the support structure with the anchor member, anchor seat, and at least a portion of the shank positioned in a recess formed in the support structure.

The base plate may include a boss configured to extend into a boss recess formed in an adjacent positioned anchor assembly. The boss and the anchor seat may extend from a common surface of the base plate. The anchor member may be pivotally mounted to the anchor seat to permit pivotal movement of the connector relative to the base plate. Mounting the base plate may include securing the base plate to a surface of the support structure. The anchor assembly may further include at least one spring biasing member configured to bias the base plate into contact with the surface of the support structure.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a front perspective view of an example cable anchor assembly in accordance with the present disclosure.

FIG. 2 is a rear perspective view of the cable anchor assembly shown in FIG. 1.

FIG. 3 is an exploded rear perspective view of the cable anchor assembly shown in FIG. 1.

FIG. 4 is a side view of the cable anchor assembly shown in FIG. 1.

FIG. 5 is side view of the cable anchor assembly shown in FIG. 1 in an angled position.

FIG. 6 is a top view of the cable anchor assembly shown in FIG. 1.

FIG. 7 is a cross-sectional view of the cable anchor assembly shown in FIG. 6 taken along cross-section indicators 7-7.

FIG. 8 is a perspective view of the cable anchor assembly shown in FIG. 1 mounted to a support structure.

FIG. 9 is an exploded perspective view of the cable anchor assembly and support structure shown in FIG. 8.

FIG. 10 is a cross-sectional view of the cable anchor assembly and support structure shown in FIG. 8 taken along cross-section indicators 10-10.

FIG. 11 is a front perspective view of another cable anchor assembly in accordance with the present disclosure.

FIG. 12 is a rear perspective view of the cable anchor assembly shown in FIG. 11.

FIG. 13 is an exploded rear perspective view of the cable anchor assembly shown in FIG. 11.

FIG. 14 is a side view of the cable anchor assembly shown in FIG. 11.

FIG. 15 is a top view of the cable anchor assembly shown in FIG. 11.

FIG. 16 is a cross-sectional view of the cable anchor assembly shown in FIG. 15 taken along cross-section indicators 16-16.

FIG. 17 is a perspective view of the cable anchor assembly shown in FIG. 11 mounted to a support structure.

FIG. 18 is an exploded perspective view of the cable anchor assembly and support structure shown in FIG. 17.

FIG. 19 is a cross-sectional view of the cable anchor assembly and support structure shown in FIG. 17 taken along cross-section indicators 19-19.

FIG. 20 is a perspective view of a plurality of base plates of the cable anchor assembly shown in FIG. 11 assembled in series.

FIGS. 21A-H show various views of another example base plate in accordance with the present disclosure.

FIGS. 22A and 22B show perspective views of a pair of the base plates of FIGS. 21A-H connected to each other.

FIG. 23 is a cross-sectional view of the pair of base plates of FIGS. 22A-B positioned in the support structure of FIGS. 8-10.

FIGS. 24A-H show various views of another example base plate in accordance with the present disclosure.

FIGS. 25A-H show various views of another example base plate in accordance with the present disclosure.

FIGS. 26A-H show various views of another example base plate in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure is generally directed to cable connection systems, devices, and methods. More particularly, the present disclosure is directed to systems, devices, and methods used to secure a cable to a support structure such as a post, wall, rail, or the like. One aspect of the present disclosure relates to an internal post insert or mounting structure used to anchor the cable connection system to a support structure. Aspects of the present disclosure may be used in other applications besides an internally positioned insert that is located within a support structure such as a post. For example, the internal post inserts disclosed herein may be positioned at other locations such as, for example, on a back side of a post, wall, or other support structure relative to the direction of travel of the cable away from the post.

Generally, the cable connection systems and devices described herein may be referred to as internal post inserts, internal inserts, post inserts, anchor inserts, or any of a variety of other names. In one example, a cable anchor assembly may provide a device that allows for a fixed or articulating anchoring point within a void in a structural element (e.g., post or rail) that is accessible from, for example, a hole formed in a wall of the structural element or an open end of the structural element. In addition to providing an anchor point for attachment of hardware to the structural element, the devices and methods disclosed herein may also provide additional support to the wall of the structural element as additional loads are introduced into the anchoring point. The devices and methods disclosed herein may also provide for a boss formed into a surface of the cable anchor assembly that is used to locate into a hole formed in the wall of the structural element that will limit movement of the device relative to the structural element. The devices and methods described herein may be designed to be used with cable connectors as an interface with the cables. The devices and methods described herein may use an anchor feature such as a shouldering pin that facilitates attachment of a cable connector. Other embodiments may implement a sphere with a socket as opposed to a cylindrical structure to facilitate a similar pivoting motion. A ball and socket design may permit rotation about additional axes rather than a single axis pivot motion provided by a cylindrical-shaped pin.

Another aspect of the present disclosure relates to a pivotal connection of a cable and its associated cable connector relative to the support structure. In one example, a cable anchor assembly includes a base plate that is fixed to a surface of the support structure, and an anchor to which the cable connector is adjustably secured. The anchor pivots relative to the base plate to provide a pivotal connection of the cable connector (and associated cable) relative to the base plate and support structure. In other embodiments, the cable connector is mounted to the base plate in a fixed angle orientation. The angled orientation may be perpendicular, parallel, or any angle there between.

The cable connector may be a swivel cable connector. The cable connector may include a threaded shank or post portion that is secured to the base plate via an anchor feature. The cable connector may also include a lock body and associated cable lock assembly that is connected to a free end of the cable. The lock body is able to rotate or swivel relative to the shank portion of the cable connector. This design provides for independent rotation of the shank portion relative to the base plate (e.g., via the anchor feature) for purposes of connecting the cable connector to the base plate and adjusting an axial position of the cable connector to the base plate to alter tension in the cable. The cable connector may include a swageless feature as part of the cable lock assembly. The swagelessfeature may operate to connect the cable connector to a free end of the cable.

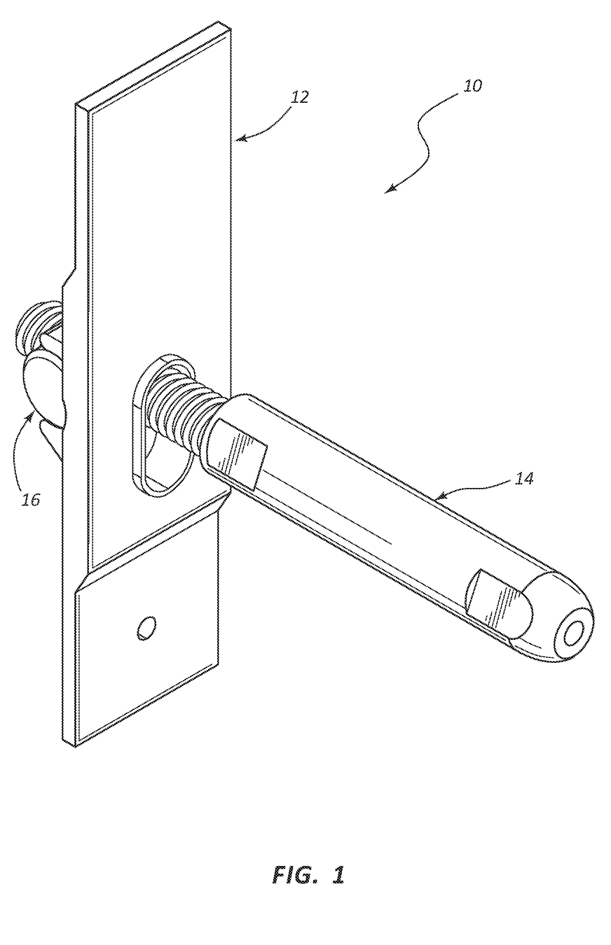

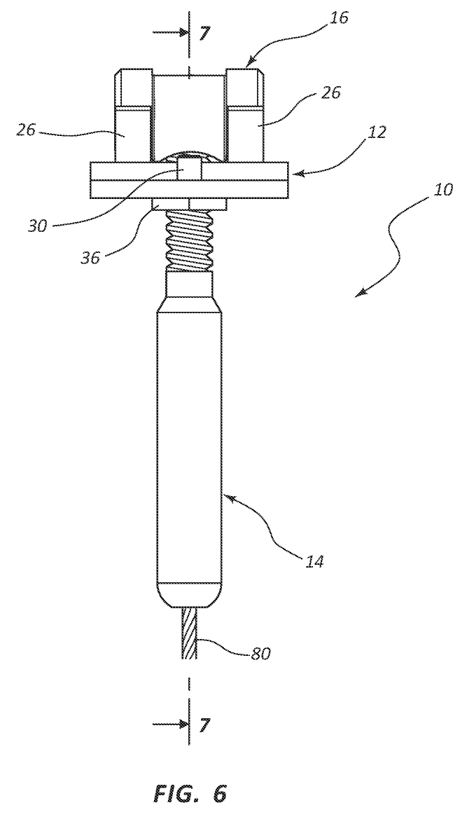

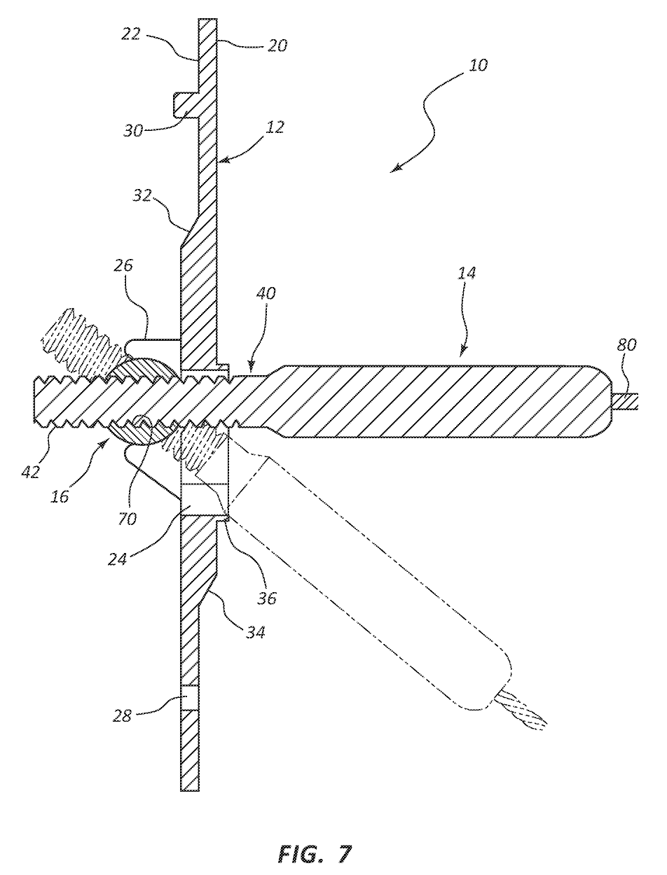

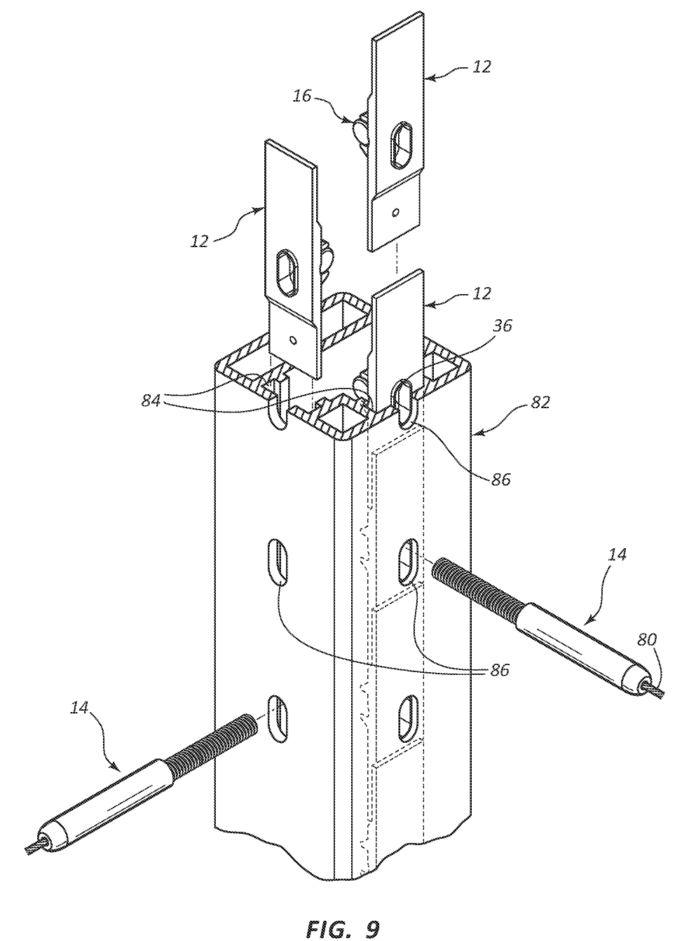

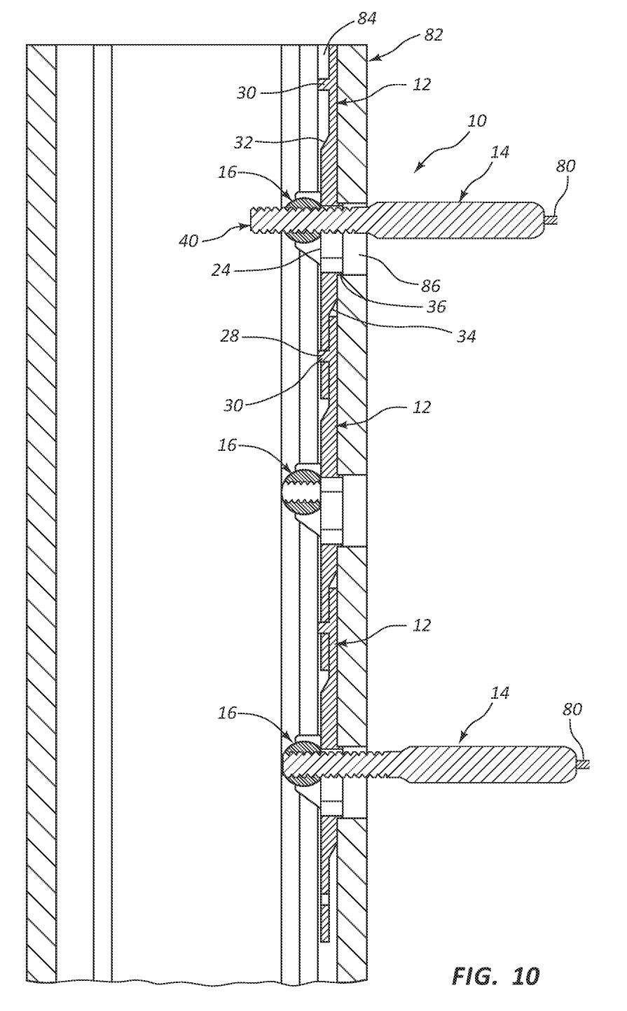

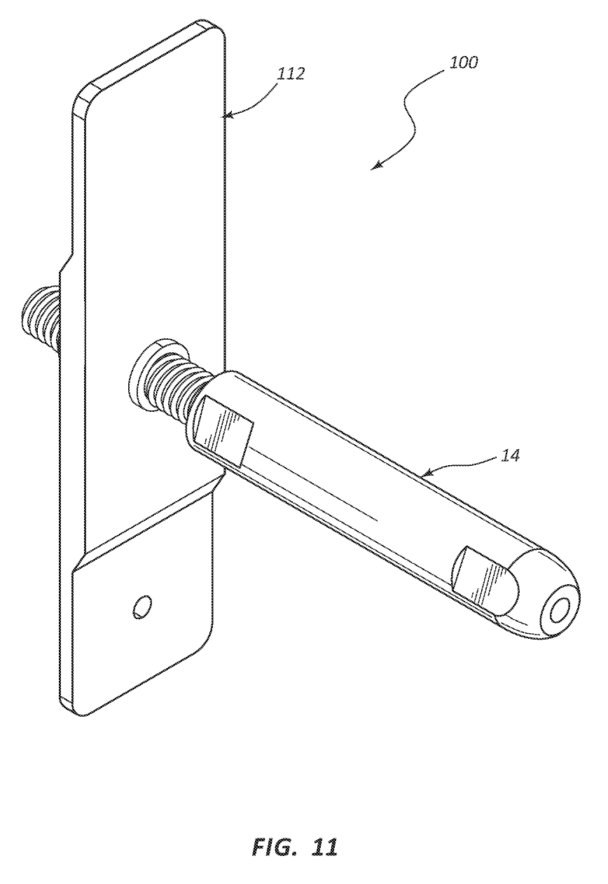

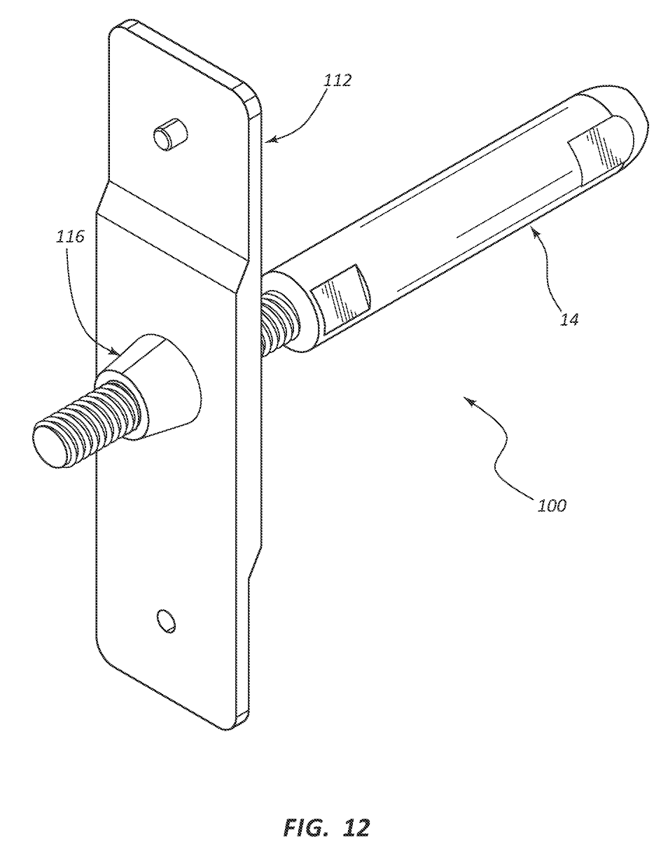

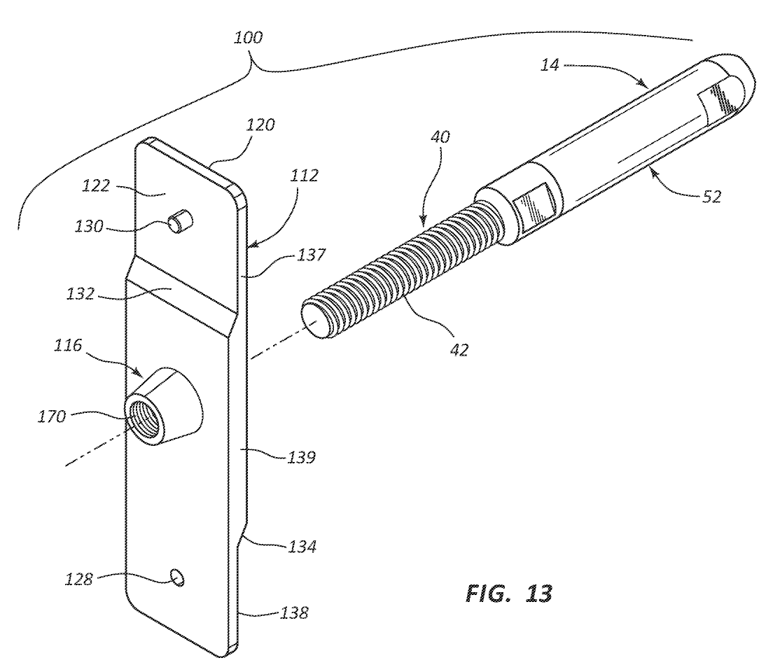

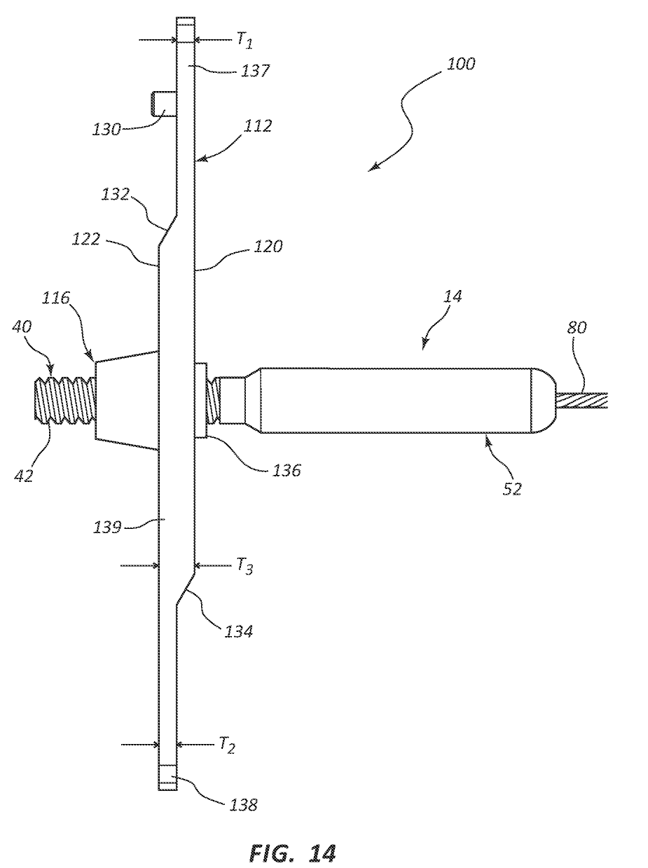

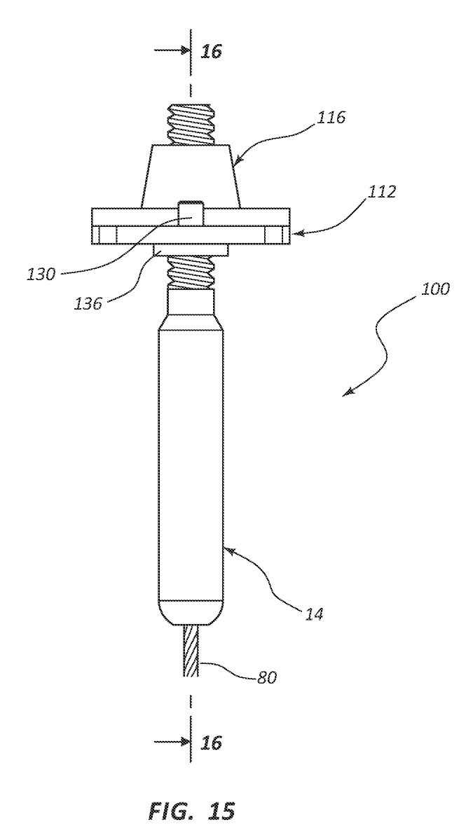

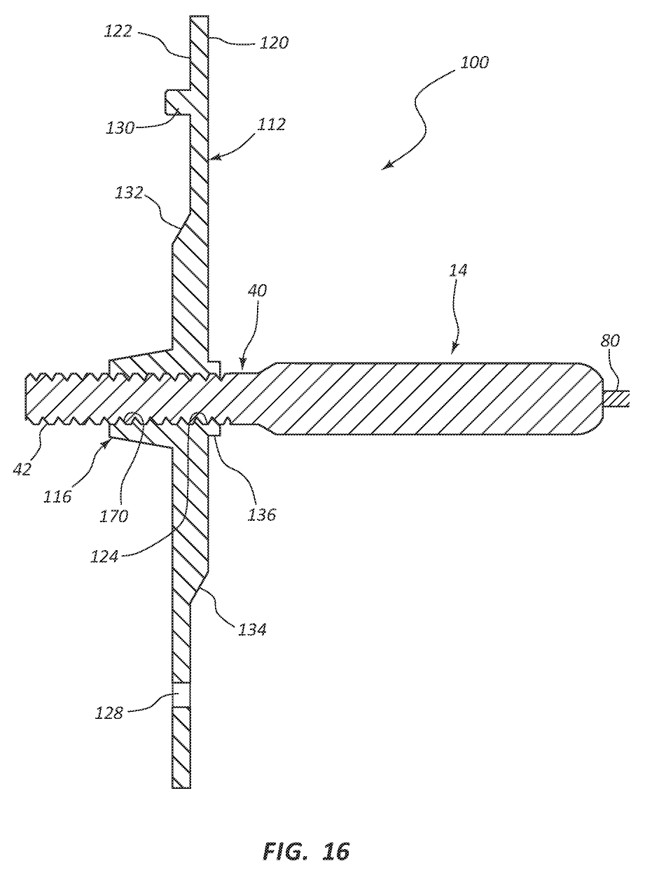

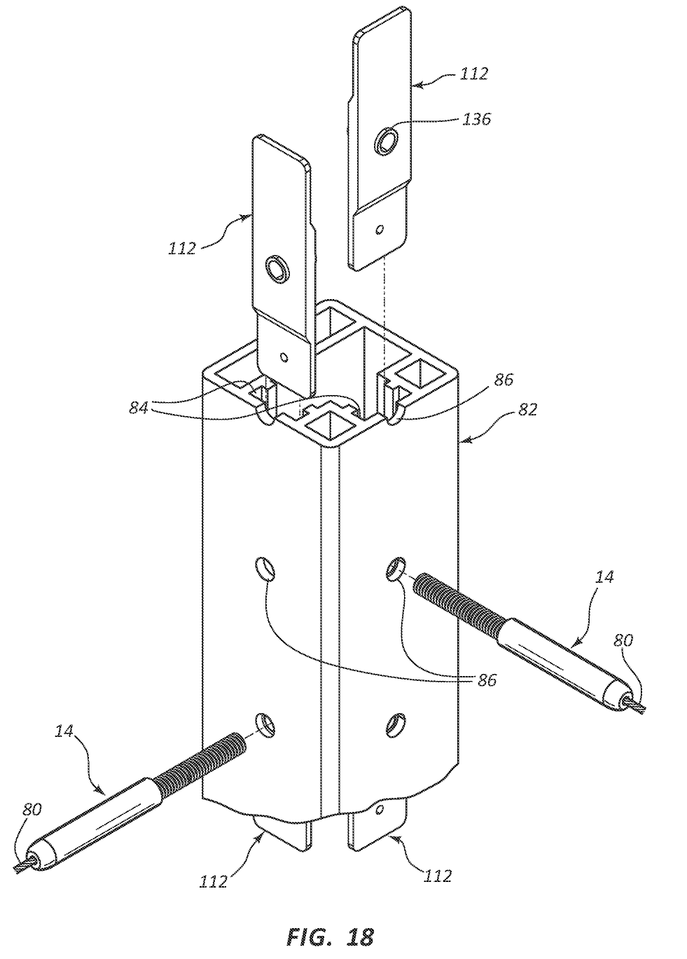

Referring now to FIGS. 1-10, an example cable anchor assembly 10 is shown and described. Cable anchor assembly 10 includes a base plate 12, a cable connector 14, and an anchor member 16. Although the term “cable” is used extensively herein, that term is not intended to be limiting and is merely representative of a variety of structures that could be anchored or otherwise connected to a support structure using the inventive concepts disclosed herein. For example, the cable anchor assembly 10 may be configured to connect a cable to a support structure such as a support post. In another example, the cable anchor assembly 10 may be used to connect a rod or shaft to a support structure. The rod or shaft may include a male threaded feature at a free end thereof that provides a connection to the cable anchor assembly. A further example includes a formed end of a connecting device (e.g., cable connector 14) that is captured by an anchor feature such as anchor member 16 that is mounted to base plate 12, or directly to an anchor feature of base plate 12. The formed shapes may include, for example, a sphere, an upset, or a coined shape, any of which may facilitate a “keyed” insertion and retention into a corresponding anchor feature (e.g. anchor 16 or anchor 116 described below with reference to FIGS. 11-19).

As mentioned above, cable connector 14 may be a swivel cable connector having axially spaced apart portions that rotate relative to each other about a longitudinal axis of the cable connector. The swivel feature of the cable connector permits the cable, which is connected to one portion of the cable connector, to maintain a fixed rotated position while another portion of the cable connector is able to rotate as part of mounting the cable connector to base plate 12 and/or anchor member 16.

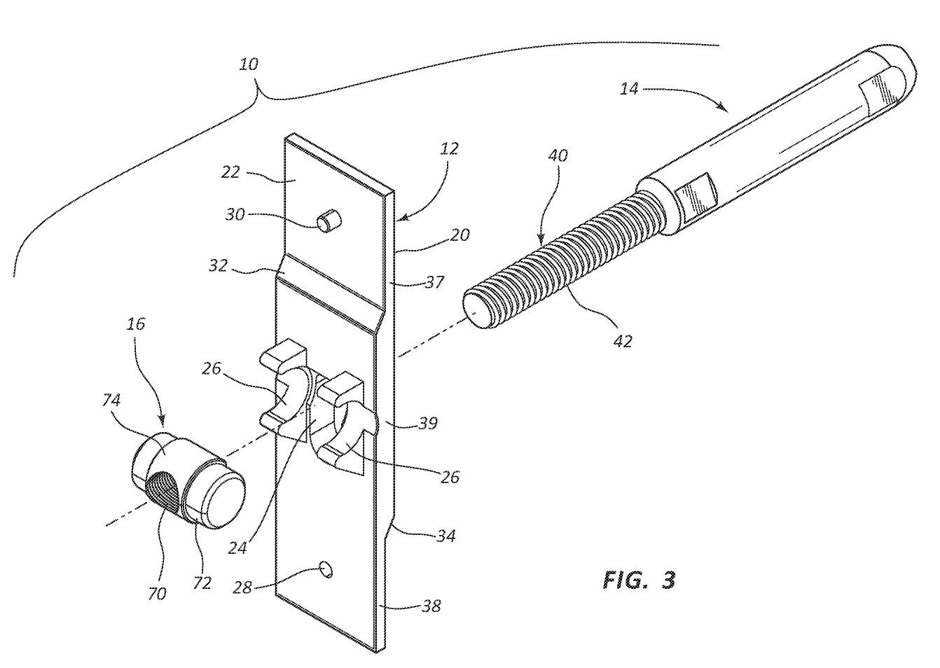

Referring to FIG. 3, base plate 12 includes inner and outer primary surfaces 20, 22, a connector aperture 24, an anchor seat 26, a boss aperture 28, a boss 30, first and second step features 32, 34, a lip 36, first and second end portions 37, 38, and a center portion 39. The connector aperture 24 has a length L and a width W. The first and second end portions 37, 38 have thicknesses T₁, T₂. Center portion 39 has a thickness T₃. Typically, the thickness T₃ of center portion 39 is greater than thicknesses T₁, T₂ to provide additional strength and support in the area of anchor seat 26. In some embodiments, base plate 12 has a constant thickness along its length, and may include more or fewer step features than those shown in the figures.

Base plate 12 is shown having a generally rectangular shape. Other shapes are possible including, for example, an oval or oblong shape, a square shape, a circular shape, or the like. The position of first and second step features 32, 34 and shape and size of first and second end portions 37, 38 may permit stacking or overlapping of portions of base plate 12 with adjacent positioned base plates.

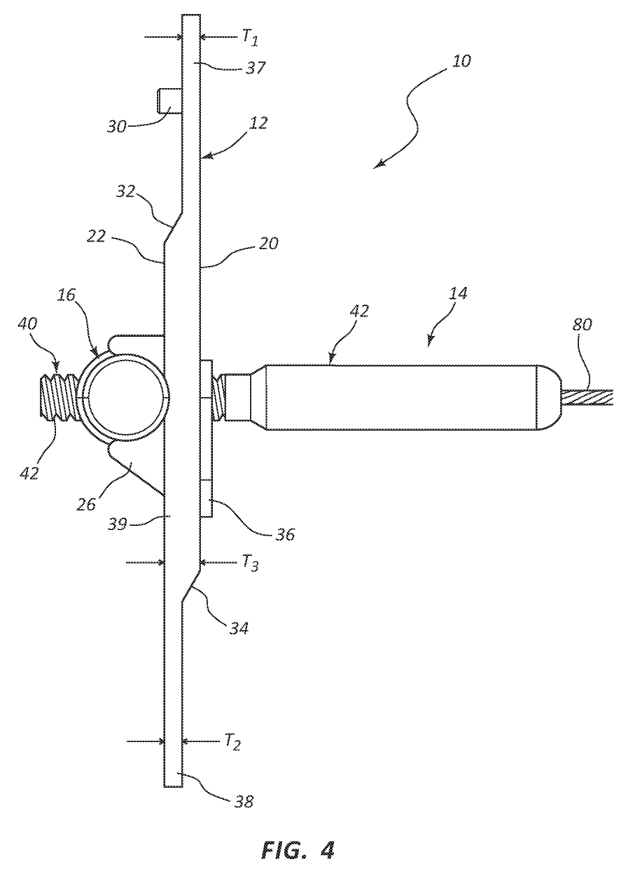

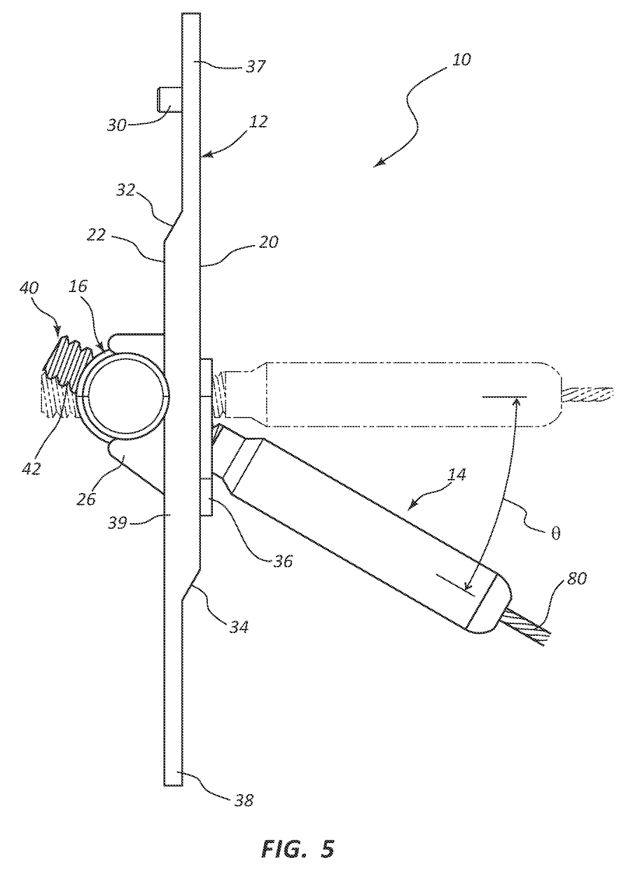

Connector aperture 24 may have a greater length L than width W. The increased length L may permit pivotal movement of cable connector 14 relative to base plate 12. The greater the length L, the greater the range of pivotal movement possible for cable connector 14 relative to base plate 3. FIG. 4 shows the angle θ of about 90°. FIG. 5 shows the angle θ at about 45°. The ends of connector aperture 24 provide a position stop for pivoting cable connector 14 relative to base plate 12. Increasing the length L may increase the range of angle θ. For example, θ may be in the range of about 15° to about 105°, and more particularly about 30° to about 90°. Typically, the width W is great enough to provide clearance between cable connector 14 and sides of connector aperture 24 while cable connector 14 pivots through angle theta θ.

In other embodiments, connector aperture 24 may have other shapes such as a circular shape. A circular shaped connector aperture 24 may provide an aperture that accommodates and/or interface with a sphere shaped anchor 16 that provides 360° rotation relative to base plate 12.

Base plate 12 may be oriented in a position shown in FIGS. 1-10 such that the cable connector 14 rotates between a horizontal position when base plate 12 is mounted to a vertical surface of a support structure, and an angled downward position. In other embodiments, base plate 12 is rotated 180° so that the cable connector 14 is pivotable between a horizontal position and a vertically upward angled orientation. In a still further embodiment, base plate 12 may be oriented in a horizontal plane such that cable connector 14 may pivot among various angled orientations within the horizontal plane. Other orientations are possible for base plate 12 relative to a vertical support surface. Furthermore, base plate 12 may be mounted to surfaces of a support structure that are arranged at different angles and orientations besides a vertical orientation.

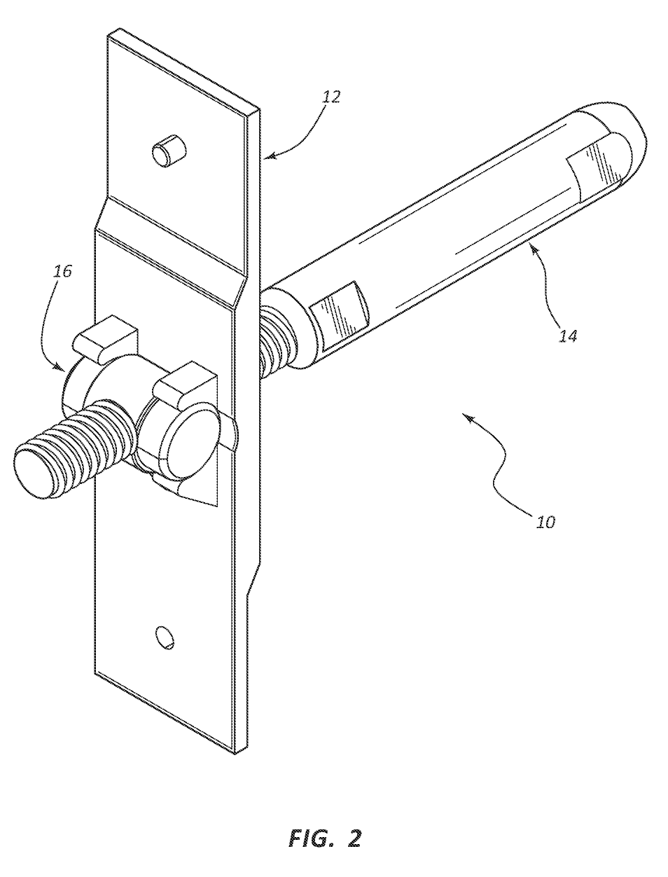

The anchor seat 26 may be sized to receive the anchor member 16. In one example, anchor seat 26 holds the anchor member 16 in a mounted position to base plate 12 with a snap-fit or interference-fit connection. The anchor seat 26 may include a plurality of contoured surfaces that interface with or mate with contoured outer surfaces of anchor member 16. Anchor seat 26 may include seat portions positioned on opposing sides of connector aperture 24 as shown in at least FIG. 2. Anchor seat 26 may have any desired shape, size, orientation, and number of features to accommodate the size, shape, and other aspects of anchor member 16 to provide a connection of anchor member 16 to base plate 12. The interface between anchor seat 26 and anchor member 16 provides for pivotal movement of anchor member 16 relative to base plate 12.

Boss aperture 28 is sized to receive a boss 30 of an adjacent positioned base plate 12. Boss aperture 28 and first step feature 32 together may help align base plate 12 with an adjacent positioned base plate and provide a releasable connection there between. Boss aperture 28 may have a circular shape or any shape that matches the shape of boss 30 received therein. Boss 30 is shown having a cylindrical shape with a circular cross-section.

Boss 30 is shown extending from outer primary surface 22 in the same direction as anchor seat 26. In other embodiments, the positions of boss aperture 28 and boss 30 may be switched so that boss aperture 28 is formed in first end portion 37 and boss 30 extends from inner primary surface 20 at second end portion 38. In other embodiments, a plurality of boss apertures 28 and bosses 30 may be positioned on a single base plate 12. Boss 30 may extend into a boss aperture formed in the support structure to assist in orienting base plate 12 relative to the support structure.

In at least some examples, boss aperture 28 may be used for other purposes besides receiving a boss 30. For example, boss aperture 28 may be receptive of a fastener such as a screw or bolt that is used to secure base plate 12 to a support structure. Many different types of fasteners or other connecting features may be used to secure base plate 12 to a support structure. For example, a fastener in combination with a bonding agent (e.g., an adhesive) may be used, or a barb may be used alone or in combination with a weld.

Lip 36 may extend from inner primary surface 20 around a periphery of connector aperture 24. Lip 36 may be inserted into a recess or aperture formed in a surface of the support structure to which base plate 12 is mounted. Lip 36 may assist in connecting base plate 12 to the support surface. Lip 36 may limit rotational movement of base plate 12 relative to the support structure. Lip 36 may provide an aligning function to help orient base plate 12 in a certain orientation relative to the support structure. Lip 36 may provide, at least in part, a stop surface that is contacted by cable connector 14 to limit pivotal movement of cable connector 14 relative to base plate 12 (see FIGS. 4 and 5). Lip 36 may be integrally formed as a single piece with remaining features of base plate 12. Similarly, anchor seat 26 and boss 30 may be integrally formed with remaining portions of base plate 12. In other embodiments, any one of the boss 30, lip 36, and anchor seat 26 may be formed as separate parts that are connected to other features of base plate 12 in a separate assembly step.

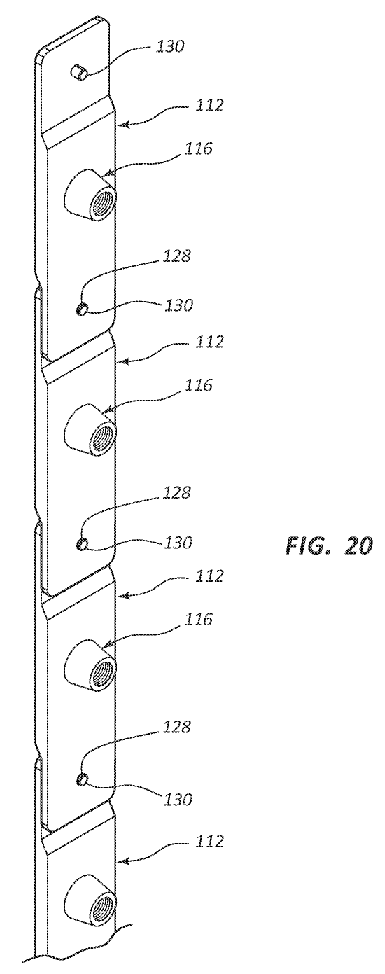

The thicknesses T₁, T₂, T₃ are typically each in the range of about 0.5 millimeters to about 5 millimeters, and more particularly about 1 millimeter to about 3 millimeters. The thicknesses T₁, T₂ are typically about 25% to about 90% of T₃ and more particularly about 30% to about 50% of T₃. The thicknesses T₁, T₂, T₃ may be optimized to provide overlapping and mating interfaces between base plate 12 and adjacent positioned base plates. A series of base plates 12 may be arranged in line with each other with the first and second end portions 37, 38 overlapping each other and bosses 30 positioned within boss apertures 28 (see FIG. 20).

Cable connector 14 includes a stud or shank 40 that includes exterior thread 42 at one end thereof The thread 42 may threadably engage a threaded bore of anchor 16. In other embodiments, shank 40 may connect to anchor 16 with other connection features, such as permanent connection features rather than the adjustable connection provided by threads 42.

A free end of a cable (e.g., cable 80 shown in FIG. 4) or other structure may be inserted into or in some way connected to cable connector 14. The connection between cable 80 and cable connector 14 may be adjustable or releasable. In one embodiment, a swageless feature may be provided on cable 80 or cable connector 14 to provide a connection between cable 80 and the cable to cable connector 14. Other types of connection features may be used in other cable connector embodiments.

Anchor member 16 includes an anchor aperture 70, a plurality of contoured surfaces 72, and a raised portion 74 (see FIG. 3). Anchor aperture 70 may be a threaded bore that is receptive of the threaded shank 40. Contoured surfaces 72 may mate with contoured surfaces of anchor seat 26 to provide relatively smooth rotation motion of anchor member 16 relative to base plate 12. Raised portion 74 may be positioned between the contoured surfaces 72 to restrict lateral movement of anchor member 16 relative to anchor seat 26.

Anchor member 16 may be secured to base plate 12 in any number of ways including, for example, being pivotally attached to anchor seat 26 using a snap-fit connection, interference-fit connection, fastener, or the like. In at least some examples, anchor member 16, when connected to base plate 12, maintains a fixed position in all directions of motion (e.g., rotational, translational, axial, etc.). An example of an anchor member 16 that is fixed relative to base plate 12 is shown and described below with reference to FIGS. 11-19.

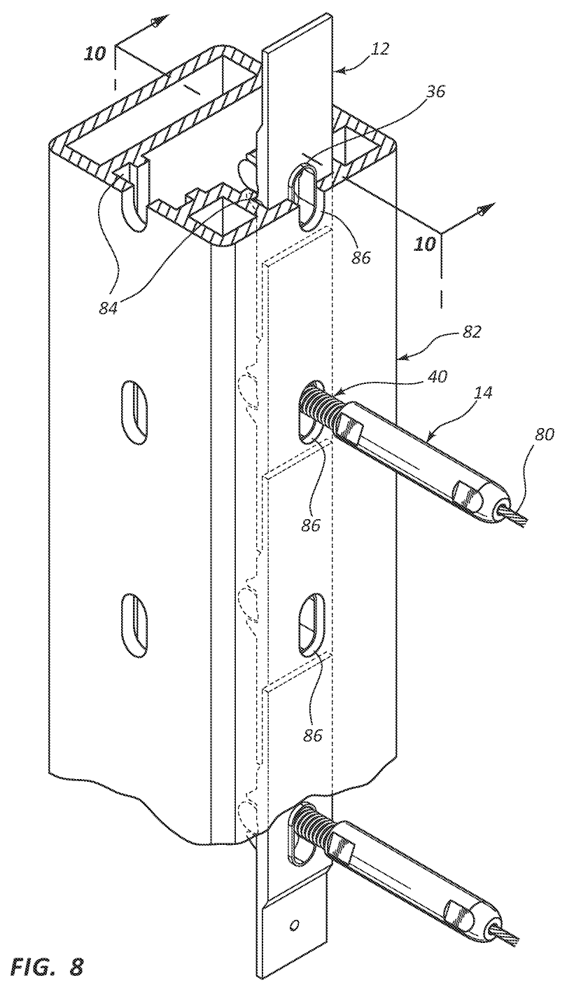

FIGS. 8-10 show the cable anchor assembly 10 connected to a cable 80 and a support structure 82. A free end of cable 80 is secured to cable connector 14. Cable connector 14 is connected to anchor member 16, which is mounted to base plate 12. Base plate 12 is inserted into a track, cavity or recess 84 of support structure 82. Lip 36 extends into an aperture 86 of support structure 82. In at least some examples, additional cable anchor assemblies 10 are positioned adjacent to the cable anchor assembly 10 shown in FIGS. 8-10 and connected together via, for example, boss aperture 28 and boss 30. In other examples, boss aperture 28 is receptive of a fastener such as a screw or bolt that extends into support structure 82 to provide a positive connection between base plate 12 and support structure 82.

FIGS. 8-10 also show the cable connector 14 extending from base plate 12 in a generally perpendicular direction. As discussed above, cable connector 14 may pivot into other angled positions relative to base plate 12 (and a surface of support structure 82) as shown in at least FIG. 5.

Referring now to FIGS. 11-19, another example cable anchor assembly 100 is shown and described. Cable anchor assembly 100 includes a base plate 112, cable connector 14, and an anchor member 116. Anchor member 116 is fixed relative to base plate 112. In at least one example, anchor member 116 is integrally formed as a single piece with base plate 12. At a minimum, anchor member 116 is operable to hold cable connector 14 in a fixed angled position relative to base plate 112. The embodiment shown in FIGS. 11-19 shows the cable connector 14 oriented in a generally perpendicular direction relative to base plate 112 when cable connector 14 is mounted to anchor member 116.

Base plate 112 includes inner and outer primary surfaces 120, 122, a connector aperture 124, a boss aperture 128, a boss 130, first and second step features 132, 134, a lip 136, end portions 137, 138, and a center portion 139. Connector aperture 124 has a generally circular shape with a constant width W. Boss aperture 128 is receptive of a boss 130 of an adjacent positioned base plate 112. Boss aperture 128 may have substantially the same shape and size as boss 130. Boss 130 is shown having a cylindrical shape with a circular cross-section. Boss 130 extends from outer primary surface 122 in the same direction in which anchor member 116 extends from base plate 112.

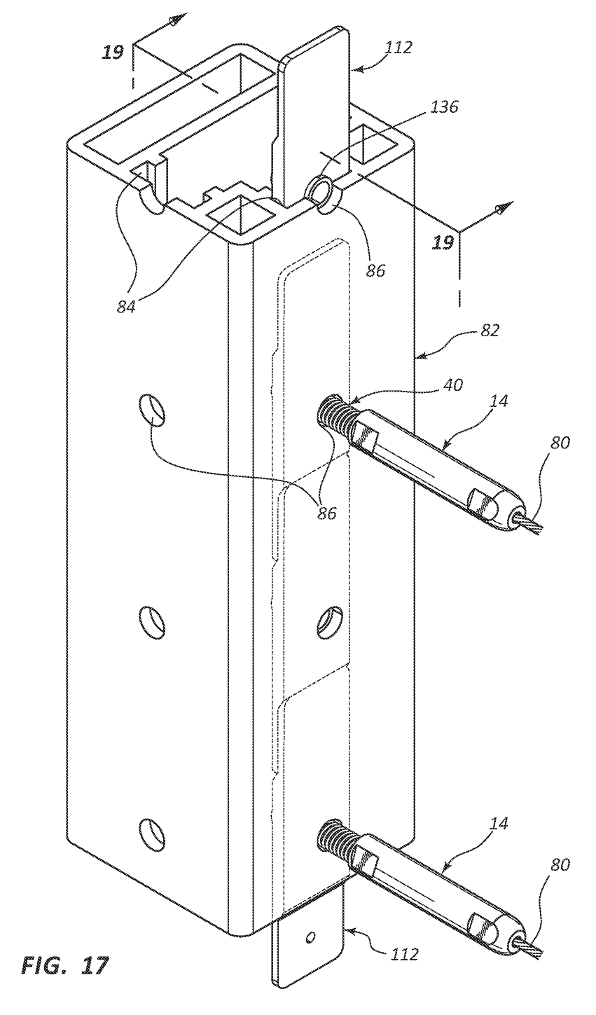

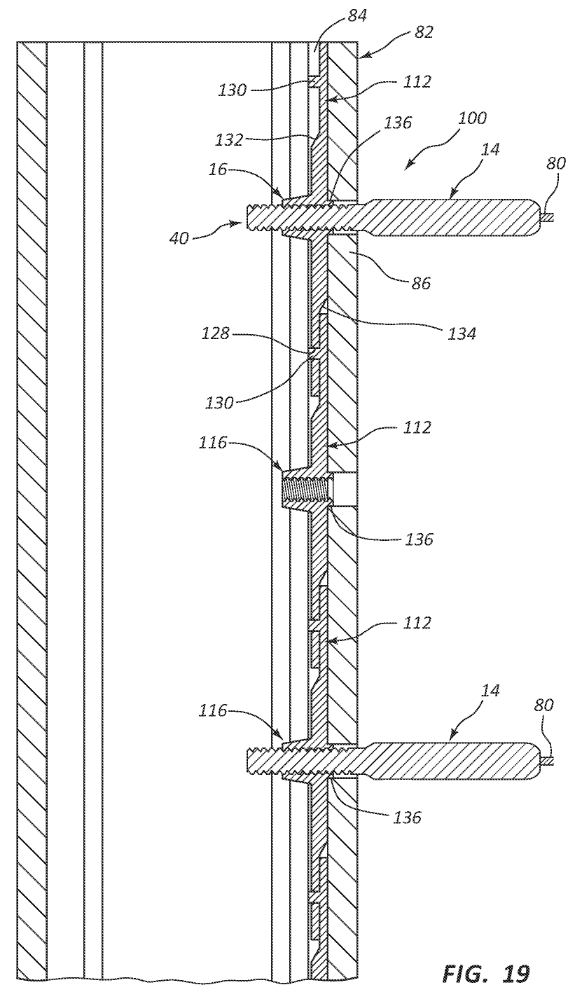

Lip 136 extends around a periphery of connector aperture 124. Lip 136 may be used to orient and help maintain an orientation of base plate 112 relative to a support surface to which cable anchor assembly 100 is connected, as shown in at least FIGS. 17 and 19. Base plate 112 may have thicknesses T₁, T₂, T₃ as described above with reference to base plate 12.

Anchor member 116 may include an anchor aperture 170. Anchor aperture 170 may be threaded and sized to receive threaded shank 40 of cable connector 14. When assembled, shank 40 extends through connector aperture 124 and into threaded engagement with anchor aperture 170. When cable connector 14 is connected to a cable or other structure (e.g., cable 80), rotating shank 40 relative to base plate 12 advances or retracts cable connector 14 relative to anchor member 16.

FIGS. 17-19 show cable anchor assembly 100 mounted to support structure 82 with cable 80 connected to cable connector 14. Base plate 112 is held in a fixed position relative to support structure 82 at least in part by lip 136. As mentioned above, a fastener may be used to fix an orientation of base plate 112 relative to support structure 82 (e.g., a screw extending through boss aperture 28).

FIG. 20 shows a plurality of cable anchor assemblies 100 connected to each other via the boss aperture 128 and boss 130 of each base plate 112. A length L of each base plate 112 may be adjusted to provide a desired spacing between each of the cable connectors 14 mounted to each base plate 112. In at least some examples, a base plate may include a plurality of boss apertures 128 or bosses 130 to adjust spacing between the base plates 112 of adjacent cable anchor assemblies 100 without adjusting the total length or size of any of the base plates 112. The interconnection of a plurality of cable anchor assemblies 100 may provide additional stability, strength, alignment, and other advantages in a cable connection system.

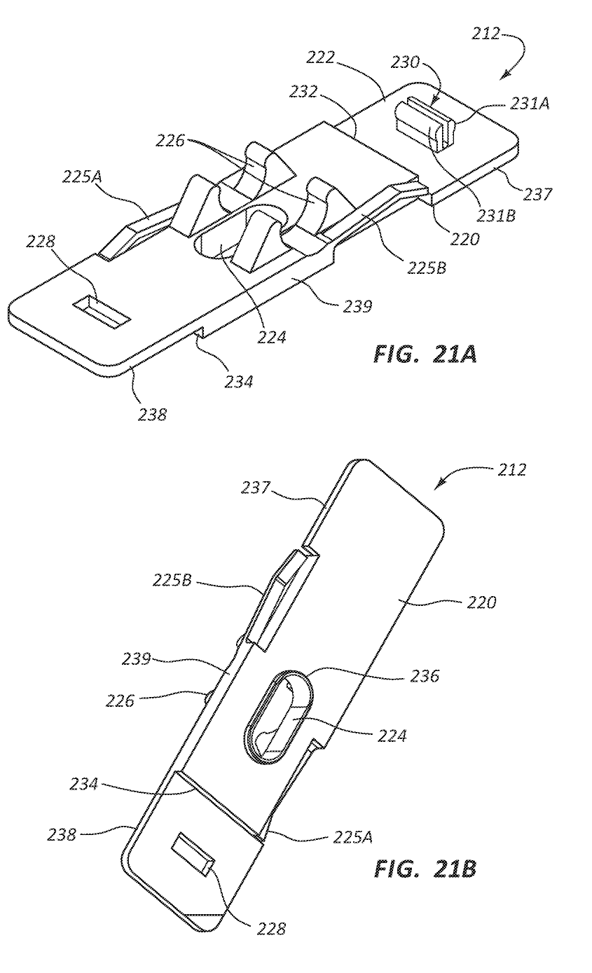

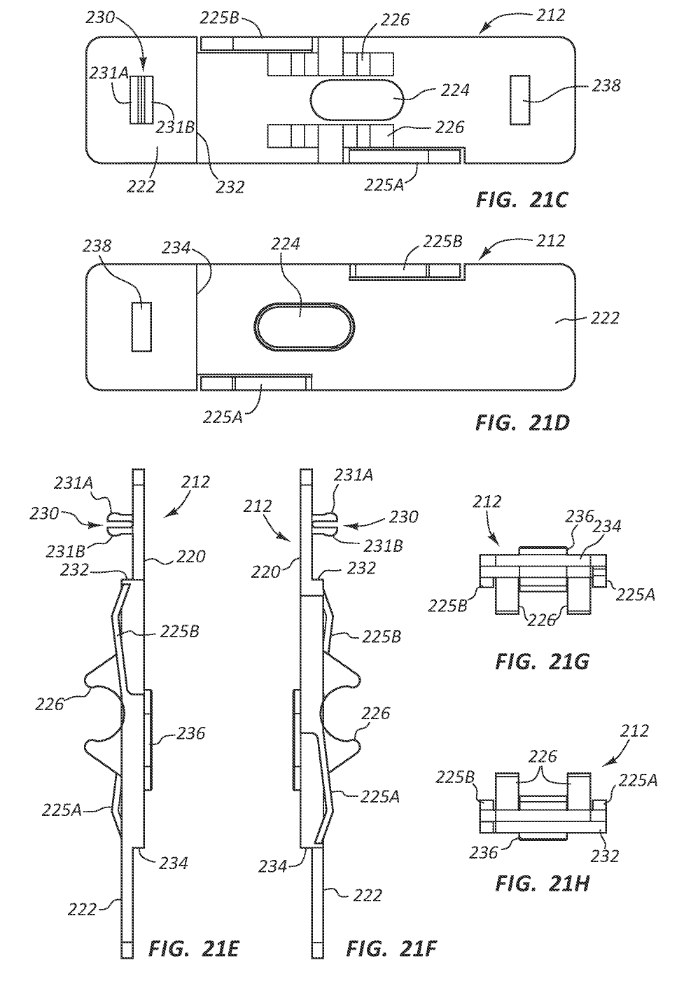

FIGS. 21A-H show another base plate 212. The base plate 212 may be one example of the base plate 12 described above with reference to FIGS. 1-10. Base plate 212 may be used in combination with a cable connector such as cable connector 14, and an anchor member such as anchor member 16, shown in FIGS. 1-10. Base plate 212 may include additional features that assist in connecting base plate 212 and its associated anchor assembly components with an adjacent positioned anchor assembly. Base plate 212 may also include additional alignment features that assist in maintaining alignment between adjacent cable anchor assemblies. Base plate 212 may include other features that assist in positioning the anchor assembly relative to a support structure such as the support structure 82 shown and described with reference to FIGS. 8-10.

Base plate 212 includes inner and outer primary surfaces 220, 222, a connector aperture 224, first and second spring biasing arms 225A, 225B, an anchor seat 226, a boss aperture 228, and a boss 230 having first and second connecting arms 231A, 231B. Base plate 212 may also include first and second step features 232, 234, a lip 236, first and second end portions 237, 238, and a center portion 239. The connect aperture 224 may be receptive of a connecting member such as cable connector 14, which extends through connector aperture 224 and into engagement with an anchor (e.g., anchor member 16) that is secured to base plate 212 at anchor seat 226.

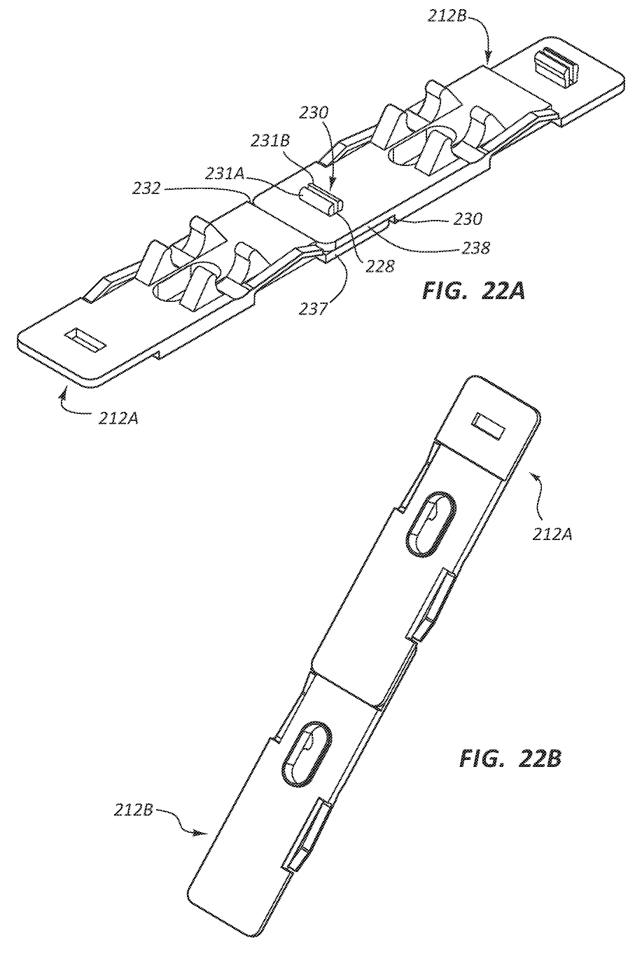

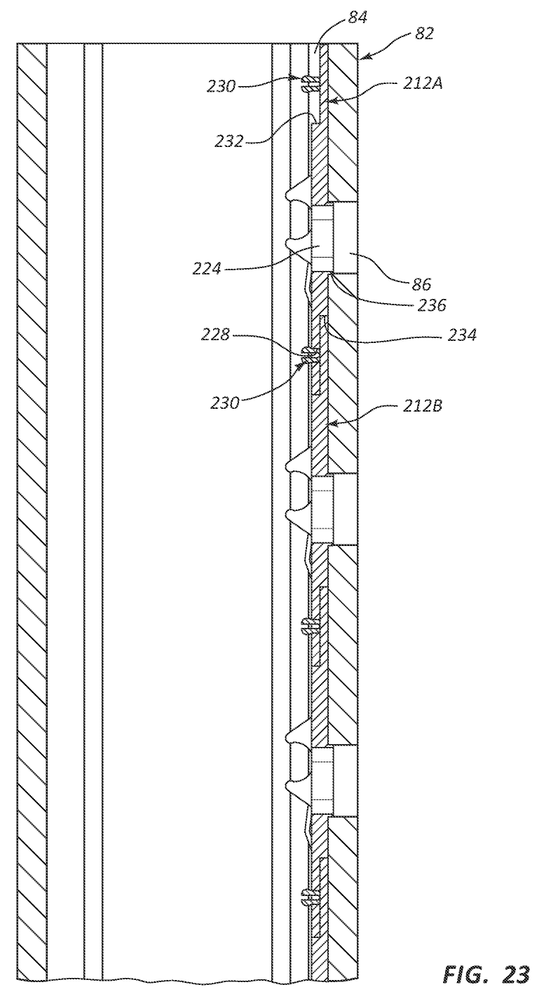

Boss aperture 228 may be shaped and sized to receive boss 230 of an adjacent positioned anchor assembly. Boss aperture 228 is shown in FIGS. 21A-H having a generally rectangular shaped perimeter with a greater width than height. The boss 230 extends through boss aperture 228. Boss 230 may provide an interference fit connection with boss aperture 228. The first and second connecting arms 231A, 231B may provide a snap-fit connection between boss 230 and boss aperture 228. The first and second connecting arms of 231A, 231B may bias or flex toward each other when passing through boss aperture 228 and then spring back into an original, unbiased position after free ends of the first and second connecting arms 231A, 231B pass through boss aperture 228. FIGS. 22A and 23 show the mated connection between boss 230 and boss aperture 228. The mated connection may be released or disconnected upon application of a sufficient force in an opposite direction from which boss 230 is inserted into boss aperture 228. The connection between boss aperture 228 and boss 230 may provide a releasable connection between base plates of adjacent anchor assemblies.

Many other designs are possible for providing a releasable connection between adjacent positioned base plates 212. In other arrangements, multiple boss members that are positioned spaced apart from each other along one of the inner or outer primary surfaces 220, 222 and may be inserted into a plurality of boss apertures 228 formed in the base plate of an adjacent anchor assembly. In at least some arrangements, the connection between the boss 230 and boss aperture 228 may provide a permanent connection in which no disconnection is possible without damaging features of the base plate (e.g., a destructive disconnection).

The first and second step features 232, 234 may provide abutment surfaces against which the first and second end portions 237, 238 of adjacent position base plates may connect to limit relative rotational movement between adjacent position base plates 212. The combination of a connection between boss aperture 228 and boss 230 along with contact between the first and/or second step features 232, 234 and one of the end portions 237, 238 may limit relative movement between adjacent connected base plates 212 in a plurality of translational and rotational directions. In at least some arrangements, one objective is to provide an assembly of interconnected base plates (and associated anchor assembly features) that remains connected prior to, during and after insertion into a receiving recess of a support structure (e.g., recess 84 of support structure 82 shown in FIGS. 8-10).

Lip 236 may have a shape and size that assists in aligning the base plate 212 relative to an aperture 86 of support structure 82 (see FIGS. 8-10). The lip 236 may extend into aperture 86 when inner primary surface 220 is facing and in contact with the support structure 82 (e.g., within a cavity or recess 84 of support structure 82 as shown in FIGS. 8-10).

Base plate 212 may include one or more spring biasing arms 225A, 225B that assists in biasing plate 212 into contact with specific surfaces of the support structure 82. For example, spring biasing arms 225A, 225B may bias base plate 212 toward aperture 84 so that lip 236 extends into aperture 84. The biasing force supplied by spring biasing arms 225A, 225B may help hold the base plate 212 in a particular orientation relative to one or more of the apertures 86 of support structure 82 (e.g., during shipping and installation).

Each base plate 212 may include a pair of spring biasing arms 225A, 225B that are positioned in a way that provide balanced application of biasing force to base plates 212. In some arrangements, the spring biasing arms 225A, 225B are positioned on opposite sides of anchor seat 226 along the center portion 239. The spring biasing arms 225A, 225B may have an elongate structure that is oriented in parallel with a length dimension of base plate 212. Other embodiments are possible in which the spring biasing arms are arranged at other orientations and positions relative to the anchor seat 226 or other features of the base plate 212.

The spring biasing arms 225A, 225B may have a free or detached end and a secure or anchor end. The free end may move toward and away from surfaces of the support structure when inserting base plate 212 into recess 84 of support structure 82. Varying the dimensions of the spring biasing arms 225A, 225B may result in adjustment of the biasing force applied. Dimensions include, for example, a length, width, thickness, angle of extension from center portion 239, a bend angle of the free distal end portion relative to the attached anchor end portion, and the like. Some arrangements include only a single spring biasing arm 225, while other embodiments may include three or more spring biasing arms for each base plate 212. In at least some examples, the spring biasing arms 225A, 225B are co-molded with remaining portions of the base plate 212. Alternatively, the spring biasing arms 225A, 225B may be molded integrally as a single piece with remaining portions of base plate 212. In further embodiments, spring biasing arms 225A, 225B may be formed separately from remaining portion of the base plates 212, and attached in a separate connecting step and/or assembly step using, for example, a fastener, bonding agent, or the like.

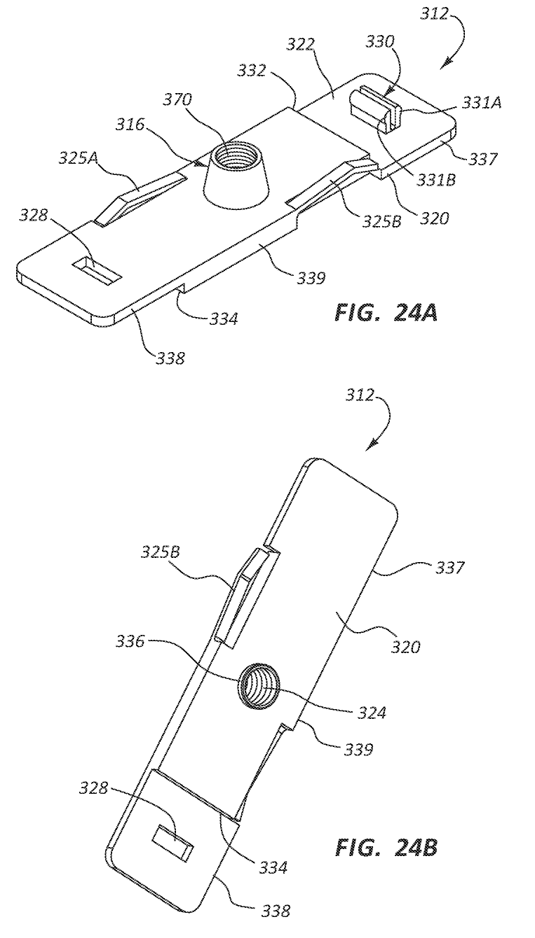

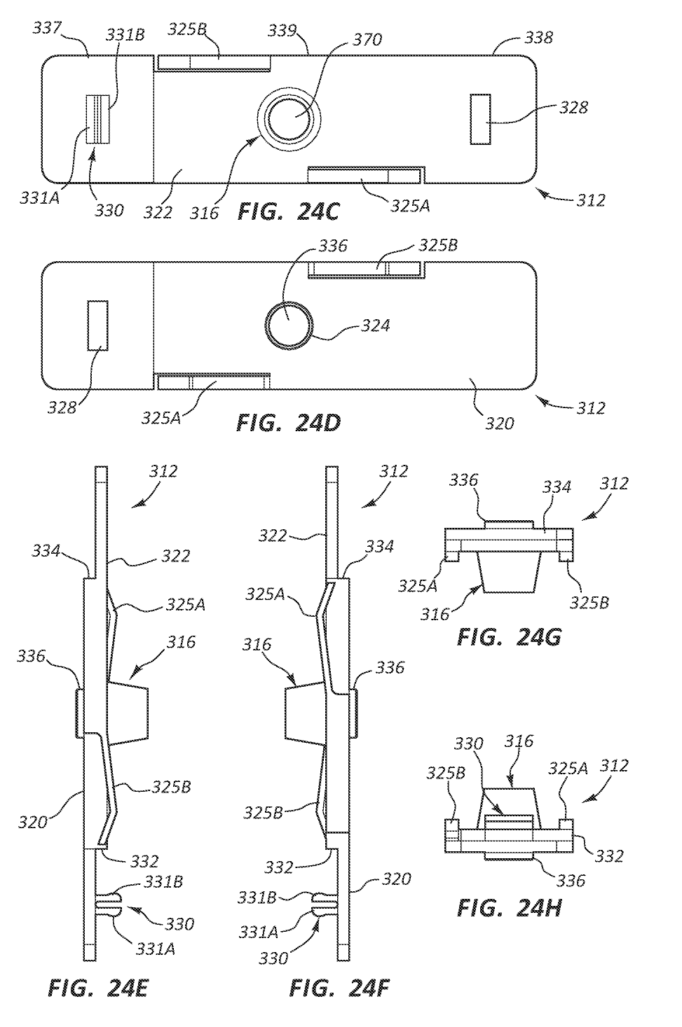

FIGS. 24A-H show another example base plate 312 for use with the cable anchor assemblies described herein. Base plate 312 may be one example of the base plate 112 described above with reference to FIGS. 11-20. Base plate 312 includes inner and outer primary surfaces 320, 322, a connector aperture 324 (see FIG. 24B), first and second spring biasing arms 325A, 325B, an anchor member 316 defining an anchor aperture 370, a boss aperture 328, and a boss 330 having first and second connecting arms 331A, 331B. Base plate 312 also includes first and second step features 332, 334, a lip 336, first and second end portions 337, 338, and a center portion 339. The anchor member 316 may be one example of the anchor member 116 described above with reference to FIGS. 11-20. The boss aperture 328 and boss 330 may be examples of the boss aperture 228 and boss 230 described above with reference to FIGS. 21A-23. The first and second step features 332, 334 may be examples of the step features 232, 234 described with reference to FIGS. 21A-23. The first and second spring biasing arms 325A, 325B may be examples of the spring biasing arms 225A, 225B described above.

The base plates 312 may be connected to an adjacent base plate via a connection between boss aperture 328 and a boss 330 of the adjacent base plate (or vice versa) to provide a string of interconnected base plates 312. Inter-connected base plates 312 may be disconnected from each other when a predetermined force is applied in an opposite direction to a direction of insertion of boss 330 into boss aperture 328 to disconnect and remove boss 330 from boss aperture 328. In typical use, such as when assembling together a plurality of base plates 312, inserting the inter-connected base plates into recess 84 of support structure 82, shipping and/or installing support structures 82 that include interconnected base plates 312, and other activities, the base plates 312 remain interconnected at all times.

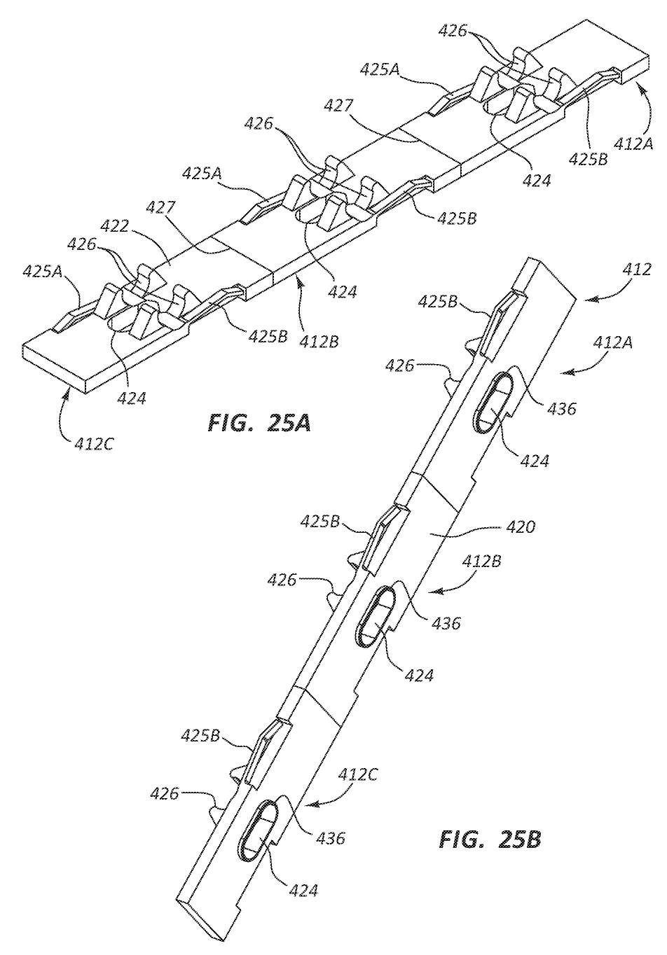

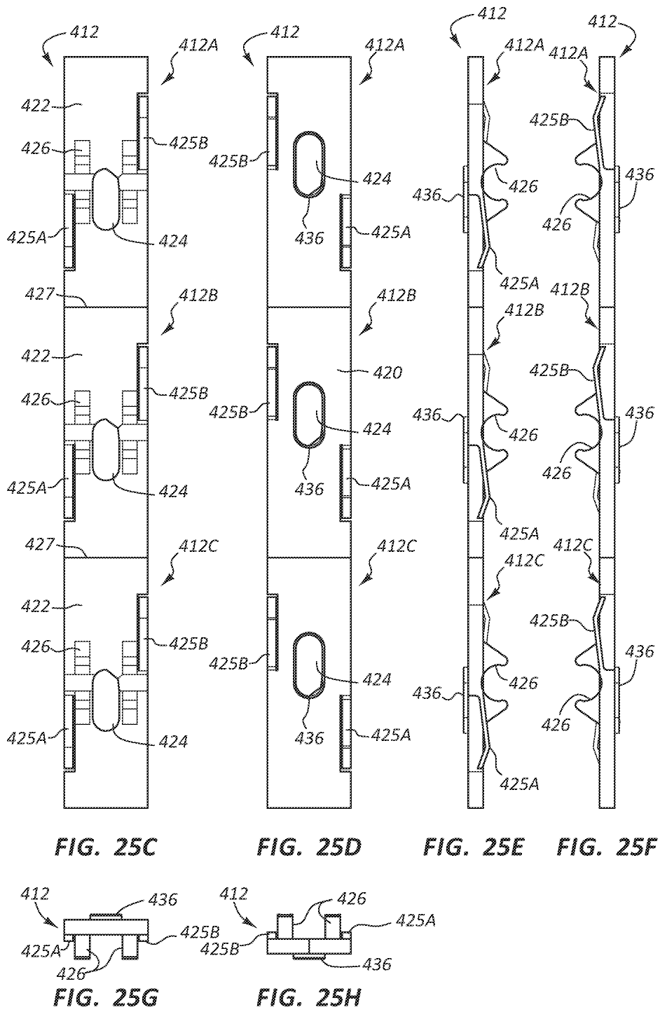

FIGS. 25A-H show another example base plate assembly 412 that includes a plurality of interconnected individual base plates 412A-C. Each of the individual base plates 412A-C may include many of the same features of the base plates 212 described with reference to FIGS. 21A-23. For example, each of the base plates 412A-C includes a connector aperture 424, an anchor seat 426 receptive of an anchor (e.g., anchor member 16), inner and outer primary surfaces 420, 422, and a pair of spring biasing arms 425A, 425B. The individual base plates 412A-C may be permanently connected to each other. The base plates 412A-C may be disconnected from each other using a cutting instrument (e.g., a saw or razor blade). In at least some examples, a break line 427 may be provided between at least some of the individual base plates 412A-C. The break lines 427 may facilitate failure at that location to provide manual disconnection of adjacent base plates 412A-C from each other.

In at least some embodiments, a relatively long string of individual base plates 412A-C may be connected to each other to provide ease of inserting the same into recess 84 of support structure 82. For example, a string of 5 to 10 individual anchor members 412A-C may be connected to each, and may be disconnected or severed in any combination such as groups of two, three or ten. In some embodiments, the string of one or more individual base plates 412A-C may be molded as one single piece.

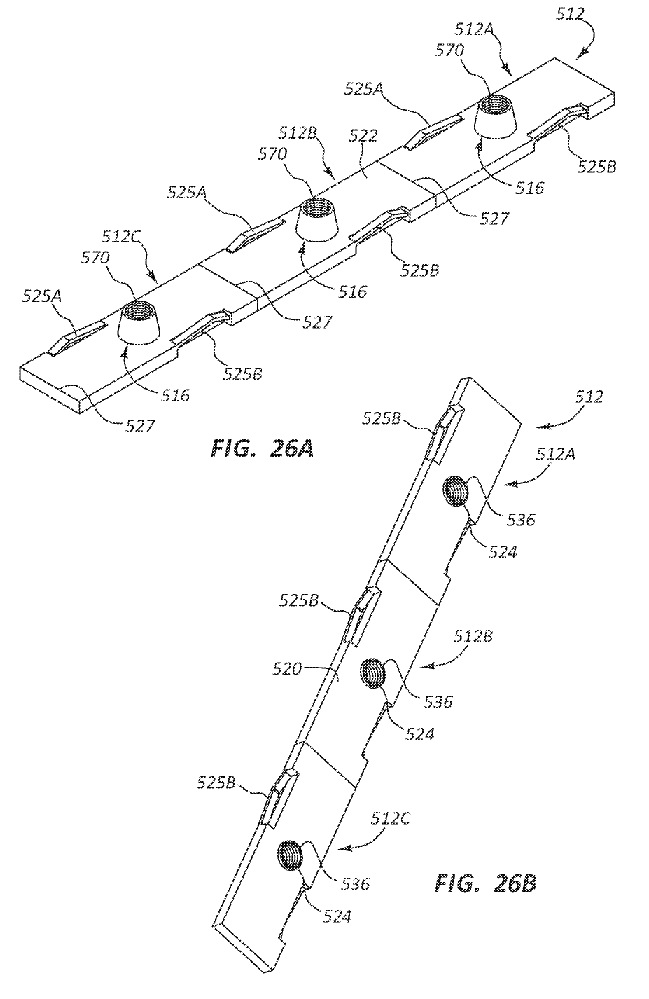

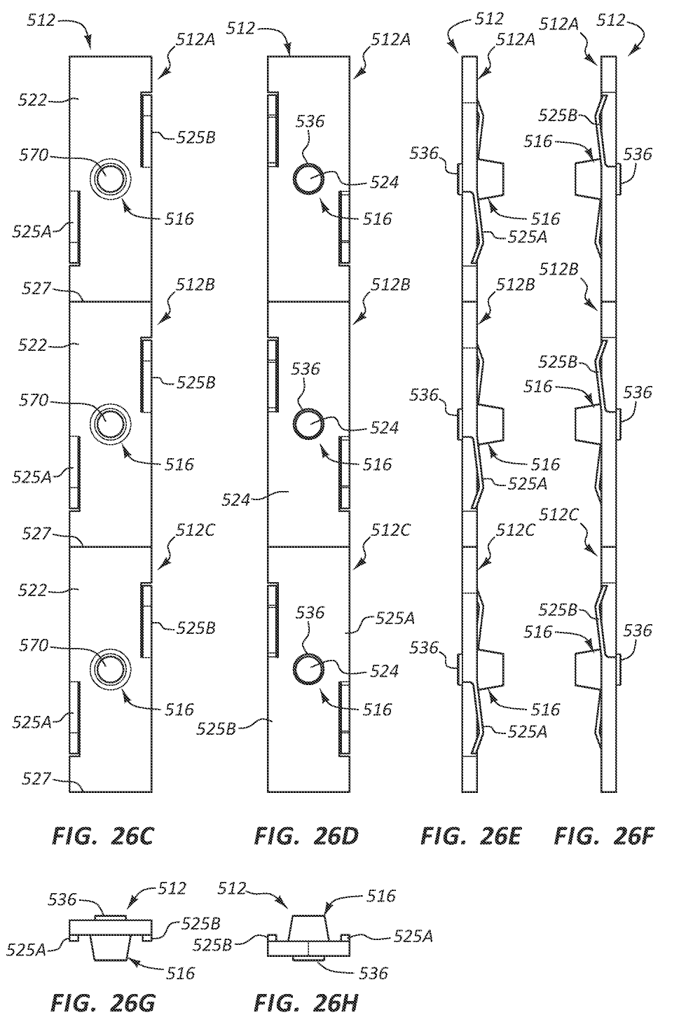

FIGS. 26A-H show another example base plate assembly 512 that includes a plurality of individual base plates 512A-C. Each individual base plate 512A-C includes at least some of the features of base plates 312 shown in FIGS. 24A-H. For example, each individual base plate 512A-C includes an anchor member 516 defining an anchor aperture 570, inner and outer primary surfaces 520, 522, a connector aperture 524, first and second spring biasing arms 525A, 525B, and a lip 536.

The base plate assembly 512 may be formed as a single piece. One or more of the individual base plates 512A-C may be separable from the others along one of the break lines 527. Individual base plates members 512A-C may be formed, disconnected from each other, or provided in any combination of numbers of base plates according to the same or similar examples described with reference base plate assembly 412 described with reference to FIGS. 25A-H.

A spacer member may be used when inserting any one of the base plates 212, 312, 412, 512 into a support structure, such as into the recess 84 of support structure 82. The spacer may be positioned between the inner primary surface of the base plate and a surface within recess 84 in which the connector apertures 86 are formed. The spacer facilitates the base plate to move axially within the recess 84 without the lip feature 36 moving into the connector aperture 86. The spacer may be removed once the lip 36 of any given base plate is aligned with an intended connector aperture 86 into which the lip 36 is to be inserted. The base plate may include a groove or recess feature formed on the inner primary surface 20 to provide additional space for the spacer to fit between the base plate and the respective surface within recess 84 of support structure 82.

In the various embodiments disclosed with reference to FIGS. 1-26H, the base plates may include a plurality of features that provide an aligning, connecting, and/or orienting function. These features may include, for example, the spring biasing arms, step features, lip, and end portions described with reference to, for example, base plate 212 shown in FIGS. 21A-23.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An anchor assembly, comprising:
an anchor member configured to releasably connect to a connector; and
a base plate, comprising:
inner and outer primary surfaces, the inner primary surface being configured to contact a surface of a support structure;
an aperture extending through the base plate and receptive of a portion of the connector; and
an anchor seat positioned on the inner primary surface and configured to support the anchor member.

2. The anchor assembly of claim 1, wherein the anchor member comprises a polymeric material.

3. The anchor assembly of claim 1, wherein the anchor member has a bore that receives a portion of the connector.

4. The anchor assembly of claim 1, wherein the anchor member is pivotally mounted to the anchor seat.

5. The anchor assembly of claim 1, wherein the anchor member is mounted to the anchor seat with an interference fit connection.

6. The anchor assembly of claim 1, wherein the base plate includes a boss extending from the inner primary surface and is configured to extend into a boss recess formed in an adjacent positioned anchor assembly or in a boss aperture formed in the support structure.

7. The anchor assembly of claim 1, wherein the aperture has a length and a width, the length being greater than the width to permit pivotal movement of the connector relative to the base plate.

8. An anchor assembly, comprising:
a base plate having a connector aperture;
a connector including a shank, the shank extending through the connector aperture; and
an anchor having a bore, the bore being configured to receive the shank of the connector;
wherein a position of the connector is adjustable relative to the anchor and base plate.

9. The anchor assembly of claim 8, wherein the base plate further comprises at least one boss aperture configured to receive at least one boss of an adjacent positioned anchor assembly to connect the base plate to the adjacent positioned anchor assembly.

10. The anchor assembly of claim 8, wherein the anchor is pivotally mounted to the base plate.

11. The anchor assembly of claim 10, wherein the anchor provides pivotal movement of the connector relative to the base plate.

12. The anchor assembly of claim 8, wherein the anchor is integrally formed as a single piece with the base plate.

13. The anchor assembly of claim 8, wherein the anchor holds the connector in a fixed orientation relative to the base plate.

14. The anchor assembly of claim 8, wherein the base plate includes a boss configured to extend into a boss recess formed in an adjacent positioned anchor assembly.

15. The anchor assembly of claim 14, wherein the boss provides a snap-fit connection between the base plate and the adjacent positioned anchor assembly.

16. A method of connecting to a support structure, the method comprising:
providing an anchor assembly comprising a base plate, a connector, and an anchor member, the base plate having a connector aperture and an anchor seat;
extending a shank of the connector through the connector aperture and into engagement with the anchor member;
positioning the anchor member in the anchor seat; and
mounting the base plate to a surface of the support structure with the anchor member, anchor seat, and at least a portion of the shank positioned in a recess formed in the support structure.

17. The method of claim 16, wherein the base plate includes a boss configured to extend into a boss recess formed in an adjacent positioned anchor assembly.

18. The method of claim 16, wherein the base plate includes multiple alignment features.

19. The method of claim 16, wherein the anchor member is pivotally mounted to the anchor seat to permit pivotal movement of the connector relative to the base plate.

20. The method of claim 16, wherein mounting the base plate includes securing the base plate to a surface of the support structure.

21. The method of claim 16, wherein the anchor assembly further comprises at least one spring biasing member configured to bias the base plate into contact with the surface of the support structure.
